(19) United States
(12) Patent Application Publication
(10) Pub. No.: US 2025/0293752 A1
(43) Pub. Date: Sep. 18, 2025

(54) METHOD FOR BEAM SELECTION USING HYBRID ARTIFICIAL INTELLIGENCE (AI) AND NON-AI BASED TECHNIQUES

(71) Applicant: Apple Inc., Cupertino, CA (US)

(72) Inventors: Yushu Zhang, Beijing (CN); Huaning Niu, San Jose, CA (US); Wei Zeng, Saratoga, CA (US); Weidong Yang, San Diego, CA (US); Haitong Sun, Cupertino, CA (US); Oghenekome Oteri, San Diego, CA (US); Hong He, San Jose, CA (US); Dawei Zhang, Saratoga, CA (US)

(21) Appl. No.: 18/858,848

(22) PCT Filed: Apr. 29, 2022
(86) PCT No.: PCT/CN2022/090216

§ 371 Date: Oct. 22, 2024

(51) Int. Cl. H04B 7/06; H04B 17/318; H04L 5/00; H04W 72/23

(52) U.S. Cl. CPC H04B 7/06952; H04B 17/318; H04L 5/0055; H04W 72/23

(57) ABSTRACT

A user equipment (UE) includes a transceiver and a processor. The processor is configured to receive, from a base station and via the transceiver, a first indication of a transmission configuration indicator (TCI) state and a second indication of whether a beam selected for downlink (DL) transmission to the UE was selected based on an artificial intelligence (AI) based algorithm. The beam is identified by the TCI state. The processor is also configured to determine a quality of one or more DL transmissions transmitted over the beam, and to transmit, to the base station and via the transceiver, a third indication of the quality of the one or more DL transmissions over the beam.

### TECHNICAL FIELD

This application relates generally to wireless communication systems, including methods and implementations of beam selection using hybrid of artificial intelligence (AI) and non-AI based techniques.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates an example message or event flow between a base station and a user equipment (UE), according to embodiments described herein.

FIG. 3 illustrates another example message or event flow between a base station and a user equipment (UE), according to embodiments described herein.

FIG. 4 illustrates yet another example message or event flow between a base station and a user equipment (UE), according to embodiments described herein.

FIG. 5 illustrates an example of a medium access control (MAC) control element (CE) (MAC CE) format, according to embodiments described herein.

FIG. 6 illustrates another example of a MAC CE format, according to embodiments described herein.

FIG. 7 illustrates an example flow-chart of operations being performed by a UE, according to embodiments described herein.

FIG. 8 illustrates an example flow-chart of operations being performed by a base station, according to embodiments described herein.

FIG. 9 illustrates another example flow-chart of operations being performed by a UE, according to embodiments described herein.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

In the present disclosure, various embodiments related to beam selection for downlink (DL) transmission are described. In particular, various embodiments are related to fallback methods for beam selection for the DL transmission. A beam may be selected by a base station using an artificial intelligence (AI) based algorithm. However, when signal quality measurements performed by a user equipment (UE) based on a number of DL transmissions over the beam selected using the AI based algorithm are inferior in comparison with signal quality measurements performed by the UE based on a number of DL transmissions over an alternate beam, the UE may request the base station to select a beam for DL transmission without using the AI based algorithm. The alternate beam may be selected using a beam sweeping technique.

Alternatively or additionally, the base station may automatically deactivate beam selection using an AI based algorithm in response to receiving a predetermined number of consecutive indications suggesting signal quality measurements performed by a UE based on a number of DL transmissions over a beam selected using an AI based algorithm are inferior in comparison with signal quality measurements performed by the UE based on a number of DL transmissions over an alternate beam selected using a beam sweeping technique.

Accordingly, various embodiments are described with regard to a UE and/or a base station. However, reference to the UE or the base station is merely provided for illustrative purposes. The example embodiments may be utilized with any electronic component that may establish a connection to a network or other device connected to the network, and is configured with the hardware, software, and/or firmware to exchange information and data. Therefore, the UE and/or the base station as described herein is used to represent any appropriate electronic device.

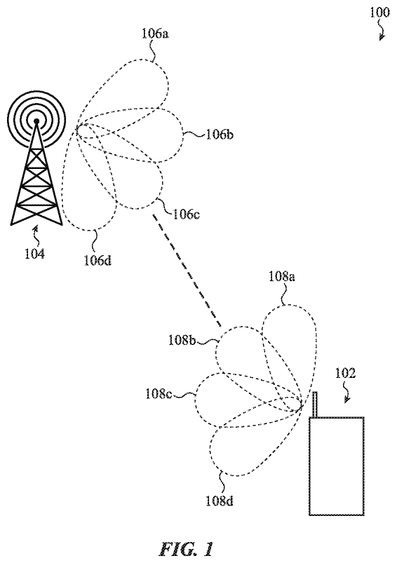

FIG. 1 shows an example wireless communication system 100, according to embodiments described herein. The wireless communication system 100 may operate in accordance with the LTE system standards, 5G or NR system standards, or other standards provided by 3GPP technical specifications.

As shown in FIG. 1, the wireless communication system 100 may include a UE 102 and a base station 104 (e.g., eNBs or gNBs). The UE 102 may communicate with the base station 104, sequentially (e.g., in a handover scenario) or simultaneously (e.g., in a carrier aggregation (CA) scenario). The UE 102 may also communicate with one or multiple transmission and reception points (multi-TRPs), on one or more base stations 104, in a multi-TRP mode. The UE 102 may also communicate with other base stations 104. In some embodiments, the UE 102 may be one of multiple UEs that simultaneously or contemporaneously communicate with one or both of the base stations 104 (or other base stations). In some embodiments, one or both of the base stations 104, alone or in combination with one or more other base stations, may form part or all of a cellular RAN.

In some cases, the base station 104 may transmit one or more DL channels to the UE 102. The DL channels may be transmitted on one or multiple DL beams 106 (e.g., DL beams 106-1, 106-2, 106-3, and/or 106-4). Similarly, the UE 102 may transmit one or more UL channels to the base station 104. The UL channels may be transmitted on one or multiple UL beams 108 (e.g., UL beam 108-1, 108-2, 108-3, and/or 108-4).

In some cases, the UE 102 and a base station 104 may communicate on a single CC. In other cases, the UE 102 and the base station 104 may communicate on multiple CCs in a carrier aggregation (CA) mode. The UE 102 may also communicate with more than one base station 104 simultaneously over a set of multiple CCs.

In 3GPP Release 17 (Rel-17), a TCI framework for unified beam management (BM) is described. In accord with the TCI framework, radio resource control (RRC) may be used to identify a set of TCI states (e.g., a TCI state list or pool) for at least one of a number of CCs that have been configured to a UE in a CA mode. A TCI state pool may be identified for one or more CCs and, in some cases, shared with one or more other CCs. A base station may indicate to the UE, in a MAC CE or downlink control information (DCI, such as DCI format 1_1/1_2), which TCI state in a TCI state list or pool is to be used for transmission of various DL and/or UL channels over a CC. The TCI state may be indicated to the UE by means of a TCI ID.

The TCI states in a TCI state list may include TCI states associated with one or more different TCI configuration modes. For example, a TCI state may be provided for a joint TCI configuration mode (i.e., a mode in which a joint TCI state indicates a downlink reference signal for beam indication for both DL and UL channels) or a separate TCI configuration mode (i.e., a mode in which a separate TCI state (e.g., a DL TCI state or an UL TCI state) indicates a downlink reference signal for beam indication for DL channels or UL channels, but not both).

In some cases, beamforming and beam selection procedures may be performed by a UE and/or a base station to increase system performance. In some embodiments, a beam selection procedure may be performed using an AI based algorithm. By way of a non-limiting example, the AI based algorithm may be used with a machine-learning algorithm, a neural-network based algorithm, and so on. The machine-learning algorithm may be a supervised and/or unsupervised machine-learning algorithm.

In alternate methods of beam selection procedure, a beam sweeping technique or method may be used by a base station and/or a UE, in which a base station may transmit a number of downlink (DL) reference signals (RS) to the UE for the UE to perform measurements for determining the quality of a number of beams. Accordingly, one or more DL RS are transmitted over one or more beams. The UE may use different Rx beams to receive a different instance of one DL RS to identify the best UE beam for each base station beam. For identifying the best beam pair including a base station's beam and a UE's beam, the UE may be required to perform signal quality measurements for multiple beams of the base station using a UE beam sweeping method. The UE may transmit to the base station a beam report identifying a quality of the multiple beams. The base station may then provide a transmission configuration indicator (TCI) state indication to provide which base station beam is used for DL transmission by the base station.

The beam selection procedure that is based on a beam sweeping method may have significant time overhead, which may be reduced by a beam selection procedure, as described herein in various embodiments, in which a beam may be selected using an AI based algorithm. Accordingly, a UE may not be required to perform signal quality measurements for all of the beams to select the best beam pair including a base station's beam and a UE's beam. The best base station beam may therefore be selected for DL transmission using an AI based algorithm so that the UE can identify the best UE beam to accommodate the best base station beam.

In some embodiments, and by way of a non-limiting example, a FR1 channel may be used to predict a beam for a FR2 channel. However, even though beam selection using an AI based algorithm improves performance, various unpredicted factors may cause the beam selected using the AI based algorithm to not provide the best signal quality for the DL transmission. By way of an example, the beam selected using the AI based algorithm may not produce the best beam pair for communication between the base station and the UE. Accordingly, when the beam selected using the AI based algorithm fails to produce the best beam pair, an alternate beam may be required to be selected using a non AI based algorithm. By way of a non-limiting example, the alternate beam may be selected using a beam sweeping method.

In the present disclosure, various embodiments correspond to an indication of whether an indicated TCI is selected based on an AI based algorithm or non AI based algorithm, and receiving an acknowledgement (ACK) or a negative acknowledgement (NACK) for the received TCI indication. Various embodiments described herein also correspond to a fallback method to select a beam using a non AI based algorithm when signal quality measurements performed by a UE indicates a beam selected using an AI based algorithm is unacceptable or having a quality below a particular threshold.

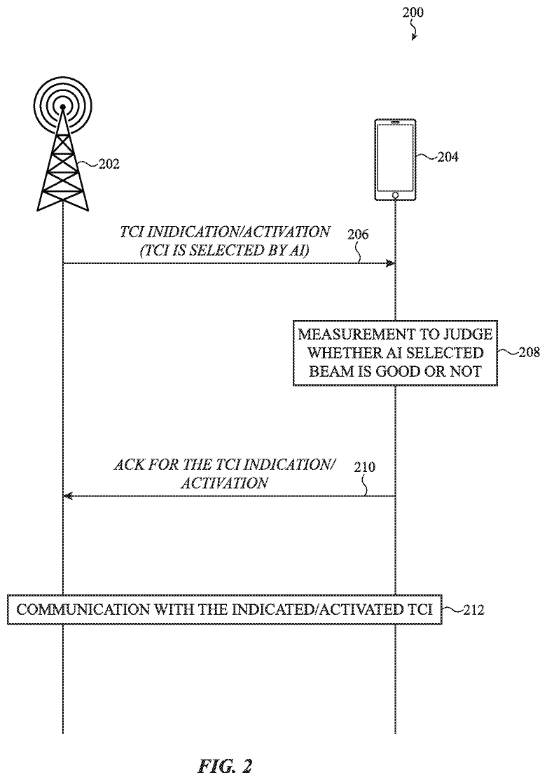

FIG. 2 illustrates an example message or event flow between a base station and a user equipment (UE), according to embodiments described herein. A message or event flow 200 describes exchange of messages and/or events between a base station 202 and a UE 204. As shown in FIG. 2, the base station 202 may send a TCI indication or TCI activation 206 to the UE 204 indicating whether the TCI is selected based on an AI based algorithm or a non-AI based algorithm.

In some embodiments, TCI indications for a CC may be configured in a joint TCI configuration mode. A base station may use RRC signaling to identify, for a UE, a TCI state list (or pool) including a number of possible joint TCI states for a CC. The base station may indicate, to the UE and in a MAC CE, which of the joint TCI states is to be used by a CC for receiving DL channels and/or transmitting UL channels over the CC. Alternatively, the base station may indicate, to the UE and in DCI, which of the joint TCI states is to be used by a CC for receiving DL channels and/or transmitting UL channels over the CC. Optionally, the base station may indicate a down-selection of “active” joint TCI states in a MAC CE, and then indicate a selection of a joint TCI state from among the down-selection of active joint TCI states. Accordingly, in some embodiments, the joint TCI state may be indicated to the UE by means of a TCI ID.

In some embodiments, TCI indications for a CC may be configured in a separate TCI configuration mode. A base station may use RRC signaling to identify, for a UE, a TCI state list (or pool) including a number of possible separate TCI states (e.g., DL TCI states and UL TCI states) for a CC. The base station may indicate, to the UE and in a MAC CE, which of the separate TCI states (e.g., DL TCI state and UL TCI state) are to be used by a CC for receiving DL channels and/or transmitting UL channels over the CC. Alternatively, the base station may indicate, to the UE and in DCI, which of the separate TCI states (e.g., DL TCI state and UL TCI state) are to be used by a CC for receiving DL channels and/or transmitting UL channels over the CC. Optionally, the base station may indicate a down-selection of “active” separate TCI states (TCI codepoints) in a MAC CE, and then indicate a selection of one or more separate TCI states in terms of a selected TCI codepoint. In some embodiments, and by way of a non-limiting example, a base station may alternatively select only a DL TCI state or a UL TCI state for one or more TCI codepoints. Accordingly, in some embodiments, the separate TCI states may be indicated to the UE by means of a TCI ID, which may include a TCI codepoint.

An indicated TCI ID can be applied to (i.e., may be common to) multiple channels within a serving cell, or across multiple serving cells (or CCs) in a CA scenario. A target set of serving cells, to which a TCI ID is to be applied, may be identified in a serving cell list configured by RRC signaling.

TCI state list sharing across serving cells is supported. A base station may optionally configure a TCI state list by RRC for one BWP in a serving cell. When a TCI state list is not configured, the TCI state list for a reference BWP in a serving cell may be used.

Accordingly, in some embodiments, and by way of a non-limiting example, to simplify beam management, the base station 202 may provide, to the UE 204 and in a MAC CE or DCI, and/or using radio resource control (RRC) signaling, an indication of whether a beam indicated in a TCI state is selected based on an AI based algorithm or using a non-AI based algorithm. In some embodiments, an indication of whether the beam indicated in a TCI state is selected based on an AI based algorithm is provided per MAC CE or per activated TCI.

In some embodiments, and by way of a non-limiting example, a TCI state indication describing whether a beam is selected based on an AI based algorithm in a DCI may be presented using a new field. The new field may be of at least 1-bit length. In some cases, whether a beam is selected based on an AI based or non-AI based algorithm may be indicated using a control channel element (CCE) index of a physical data control channel. An odd CCE index may indicate a beam is selected using an AI based algorithm and an even CCE index may indicate a beam is selected using a non-AI based algorithm, and vice versa. In some embodiments, whether a beam is selected using an AI based algorithm may be indicated using radio network temporary ID (RNTI). Alternatively, or additionally, a dedicated RNTI may be configured for TCI indication for a beam selected using an AI based algorithm.

In some embodiments, the base station 202 may also configure the UE 204 to send an ACK or NACK for the TCI indication and/or activation. As described herein, an ACK for the TCI indication and/or activation from the UE 204 may indicate that the UE 204 has determined signal quality of DL transmission over the beam selected using an AI based algorithm good or over a specific threshold or higher in comparison with an alternate beam. The alternate beam may be selected based on a non-AI based algorithm, e.g., using a beam sweeping operation.

In some embodiments, in response to receiving a TCI indication or activation suggesting a beam is selected using an AI based algorithm may cause the UE 204 to perform quality measurement to judge whether the beam selected using an AI based algorithm is good for use or not as shown in FIG. 2 as 208.

In some embodiments, before the beam identified in the TCI indication or activation is used for receiving DL transmission, the UE 204 may perform measurement using a set of channel state information reference signal (CSI-RS) resources transmitted from at least one antenna port associated with the at least one TCI state for UE beam refinement and measuring beam quality of the beam selected using an AI based algorithm. With regard to UE beam refinement, a base station may trigger a set of CSI-RS resources with repetition set to on (e.g., the CSI-RS resources in the set of CSI-RS resources will be from the same antenna port(s)). The CSI-RS resources may be quasi-co-located (QCLed) with the TCI state(s) to be activated or applied at a particular time.

In some embodiments, and by way of a non-limiting example, the CSI-RS resources may be transmitted in a predetermined or configured number of slots prior to the application time for the activated or indicated TCI state(s). The set of CSI-RS resources to be triggered by a base station may be indicated to a UE by MAC CE or DCI. The CSI-RS resources and UE beam refinement may be triggered by a single DCI or multiple DCIs.

In some embodiments, a base station may transmit another CSI-RS resource or CSI-RS resource set over a beam that is selected based on an AI based algorithm and indicated in the TCI activation or indication. Using the CSI-RS resource or CSI-RS resource sets, the UE 204 may measure beam quality of the beam selected using an AI based algorithm and indicated in the TCI state indication or activation. In some embodiments, the UE may measure signal quality of the beam based on reference signal received power (RSRP) measurement (e.g., L1-RSRP measurement) or signal-to-interference-plus-noise-ratio (SINR) measurement (e.g., L1-SINR measurement) corresponding to the beam by comparing with RSRP or SINR measurement corresponding to an alternate beam that is not selected using an AI based algorithm.

In some embodiments, the beam selected using an AI based algorithm and indicated in the TCI is considered good if its RSRP measurement or SINR measurement and corresponding RSRP measurement or SINR measurement of the alternate beam has a difference of a particular threshold offset. The particular threshold offset may be configured at the UE based on a higher layer signaling, such as RRC signaling. By way of a non-limiting example, in some embodiments, the particular threshold offset may be predefined or preconfigured.

In some embodiments, the beam selected using an AI based algorithm and indicated in the TCI is considered good based on measuring channel quality. The channel quality may be measured using RSRP, SINR, and/or CQI. By way of a non-limiting example, the CQI may be based on RSRP and/or SINR measurements, which identify channel quality based on the received signal quality. In some cases, the CQI may identify channel quality based on data rate that can be supported while using the beam selected using an AI based algorithm. If the channel quality is below a specific threshold, then the beam selected using an AI based algorithm may be determined as not good.

In some embodiments, the UE may be configured to measure signal quality in a CSI-reportConfig to report CSI based on a legacy beam (e.g., a beam selected using a beam sweeping operation) and the beam selected using an AI based algorithm using one or more measurements.

Accordingly, as described herein, if the quality of the beam selected using an AI based algorithm is found to be good or acceptable, at 210, an ACK may be sent by the UE 204 to the base station 202 for the received TCI indication or activation at 206. Because the quality of the beam selected using an AI based algorithm is acceptable, as shown in FIG. 2 as 212, communication between the UE 204 and the base station 202 may occur over the beam that is selected using an AI based algorithm.

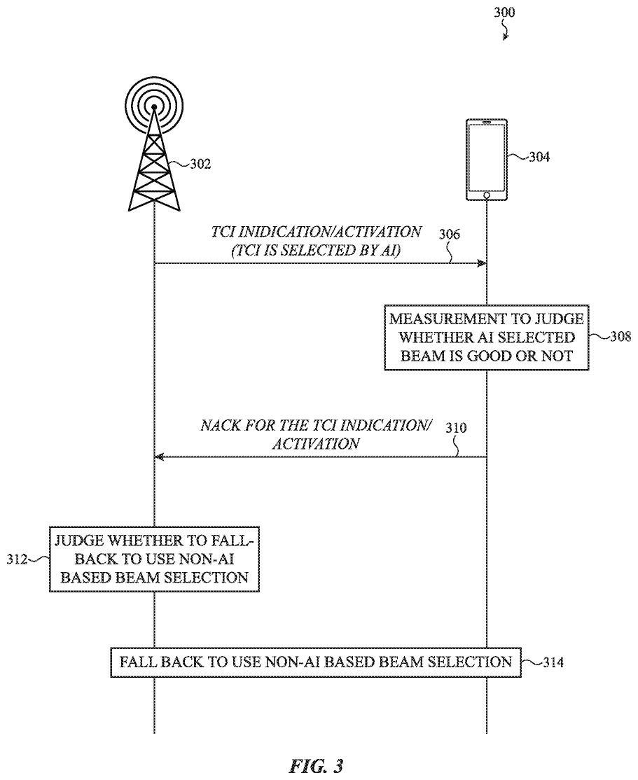

FIG. 3 illustrates another example message or event flow between a base station and a user equipment (UE), according to embodiments described herein. A message or event flow 300 describes exchange of messages and/or events between a base station 302 and a UE 304. As shown in FIG. 3, the base station 302 may send a TCI indication or TCI activation 306 to the UE 304 indicating whether the TCI is selected based on an AI based algorithm or a non-AI based algorithm. This operation presented as 306 in FIG. 3 is identical to an operation presented as 206 and discussed herein using FIG. 2 above. Accordingly, details of this operation 306 are not repeated for brevity.

In some embodiments, in response to receiving a TCI indication or activation suggesting a beam is selected using an AI based algorithm may cause the UE 304 to perform quality measurement to judge whether the beam selected using an AI based algorithm is good for use or not as shown in FIG. 3 as 308. This operation presented as 308 in FIG. 3 is identical to an operation presented as 208 and discussed herein using FIG. 2 above. Accordingly, details of this operation 308 are not repeated for brevity.

Accordingly, as described herein, and based on performed quality measurement for the beam selected using an AI based algorithm if found not to be good or acceptable, at 310, a NACK may be sent by the UE 304 to the base station 302 for the received TCI indication or activation at 306. Because the quality of the beam selected using an AI based algorithm is unacceptable, as shown in FIG. 3 as 312, the base station may determine whether to select a beam using a non-AI based algorithm or using a legacy beam sweeping operation. In other words, the base station may fall back from a beam selection using an AI based algorithm to a legacy beam selection using a beam sweeping operation. The base station may deactivate beam selection using an AI based algorithm, and communicate the same to the UE using higher layer signaling, such as RRC signaling, or using a MAC CE. Beam selection using an AI based algorithm may be deactivated when inference is performed on a UE side.

In some embodiments, and by way of a non-limiting example, the base station 302 may determine to fall back to the legacy beam selection upon receiving a predetermined number of NACKs from the UE 304 for the TCI activation or indication sent by the base station 302 at 306. In some embodiments, the predetermined number of NACKs from the UE 304 may be required to receive over a specific period. In some embodiments, the predetermined number of NACKs from the UE 304 may be required to be consecutive. Accordingly, upon meeting a condition for fallback, a beam may be selected using a non-AI based algorithm, e.g., beam sweeping operation, and so on, as shown in FIG. 3 as 314.

In some embodiments, fallback to the legacy beam selection may be determined upon activation of CSI-reportConfig for layer-1 RSRP (L1-RSRP) and/or layer-1 SINR (L1-SINR) measurement at the UE and receiving the corresponding L1-RSRP and/or L1-SINR measurement reports. In some embodiments, activation of the CSI-reportConfig may be transmitted by a MAC CE. By way of a non-limiting example, a bitmap may be provided by the MAC CE to indicate whether CSI-reportConfig is activated or deactivated. In accordance with the received CSI-reportConfig, the UE may perform L1-RSRP and/or L1-SINR measurement using DL signals. The DL signals may be DL reference signals (DL RS), such as CSI-RS, synchronization signal blocks (SSBs).

In some embodiments, an ACK or a NACK at 210 or 310 may be sent as a dedicated ACK or a dedicated NACK. In some embodiments, a TCI indication or activation at 206 or 306 may be multiplexed with other DL signals for transmitting to the UE 204 or 304 from the base station 202 or 302. A TCI indication or activation multiplexed with other DL signals requires a dedicated ACK report or a dedicated NACK report for a beam selected using an AI based algorithm. By way of a non-limiting example, the dedicated ACK/NACK report may be transmitted using a physical uplink control channel (PUCCH) resource indicated by the base station 202 or 302. The PUCCH resource may be a dedicated PUCCH resource for transmitting the dedicated ACK/NACK report as described herein. The PUCCH resource for transmitting the dedicated ACK/NACK report may be configured using higher layer signaling, e.g., RRC signaling. By way of a non-limiting example, the PUCCH resource may be configured by indicating the PUCCH resource in a MAC CE or DCI for the TCI corresponding to a beam selected using an AI based algorithm.

In some embodiments, the dedicated ACK/NACK report may be multiplexed with another normal ACK/NACK report that is transmitted by the PUCCH resource indicated by the base station 202 or 302. By way of a non-limiting example, the ACK/NACK may be hybrid automatic repeat request (HARQ) ACK/NACK. At least one bit of HARQ ACK/NACK may be used to transmit the dedicated ACK/NACK report. In some cases, the last bit in the multiplexed HARQ ACK/NACK may be used to transmit the dedicated ACK/NACK report.

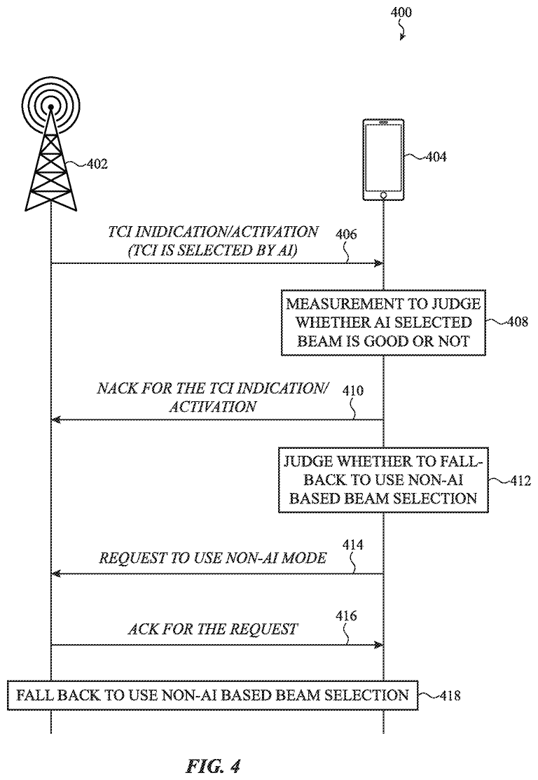

FIG. 4 illustrates yet another example message or event flow between a base station and a user equipment (UE), according to embodiments described herein. A message or event flow 400 describes exchange of messages and/or events between a base station 402 and a UE 404. As shown in FIG. 4, the base station 402 may send a TCI indication or TCI activation 406 to the UE 404 indicating whether the TCI is selected based on an AI based algorithm or a non-AI based algorithm. This operation presented as 406 in FIG. 4 is identical to an operation presented as 206 or 306. Accordingly, details of this operation 406 are not repeated for brevity.

In some embodiments, in response to receiving a TCI indication or activation suggesting a beam is selected using an AI based algorithm may cause the UE 404 to perform quality measurement to judge whether the beam selected using an AI based algorithm is good for use or not as shown in FIG. 4 as 408. This operation presented as 408 in FIG. 4 is identical to an operation presented as 208 or 308. Accordingly, details of this operation 408 are not repeated for brevity.

Accordingly, as described herein, and based on performed quality measurement for the beam selected using an AI based algorithm if found not to be good or acceptable, at 410, a NACK may be sent by the UE 404 to the base station 402 for the received TCI indication or activation at 406. Because the quality of the beam selected using an AI based algorithm is unacceptable, as shown in FIG. 4 as 412, the UE 404 may determine whether to select a beam using a non-AI based algorithm or use a legacy beam sweeping operation. In other words, the UE may fall back from a beam selection using an AI based algorithm to a legacy beam selection using a beam sweeping operation. The UE 404 may transmit a request to select a beam using a non-AI based algorithm or fall back to a legacy beam selection procedure, as shown in FIG. 4 as 414.

In some embodiments, and by way of a non-limiting example, the UE 404 may determine to fall back to the legacy beam selection upon transmitting a predetermined number of NACKs to the base station 402 for the TCI activation or indication sent by the base station 402 at 406. In some embodiments, the predetermined number of NACKs may be required to be transmitted over a specific period. In some embodiments, the predetermined number of NACKs may be required to be consecutive. Further, the predetermined number of NACKs may be configured by using higher layer signaling, such as RRC signaling, and so on.

Accordingly, upon meeting a condition for fallback, the UE may send the request to select a beam using a non-AI based algorithm or fall back to a legacy beam selection procedure, as shown in FIG. 4 as 414. In some embodiments, and by way of a non-limiting example, the request 414 may be sent in a MAC CE. A resource for the MAC CE to send the request 414 may be configured at the UE using a dedicated scheduling request (SR). In some cases, when the dedicated SR is not configured, the UE may use normal SR or content based random access procedure for requesting the resource for the MAC to send the request 414.

The base station may accept the request sent at 414 by transmitting an ACK to the UE 404 as shown in FIG. 4 as 416. By way of a non-limiting example, in some embodiments, the ACK 416 may be for disabling beam selection using an AI based algorithm, and/or activating CSI-reportConfig for L1-RSRP and/or L1-SINR measurement reports. In some cases, the ACK 416 may be a physical data control channel (PDCCH), which may be used to trigger a new transmission for the same HARQ process as the one used to report MAC CE. In some cases, the PDCCH may be transmitted in a configured dedicated search space or control resource set (CORSET). And, upon receiving an ACK at 416, a beam may be selected using a non-AI based algorithm as shown in FIG. 4 as 418.

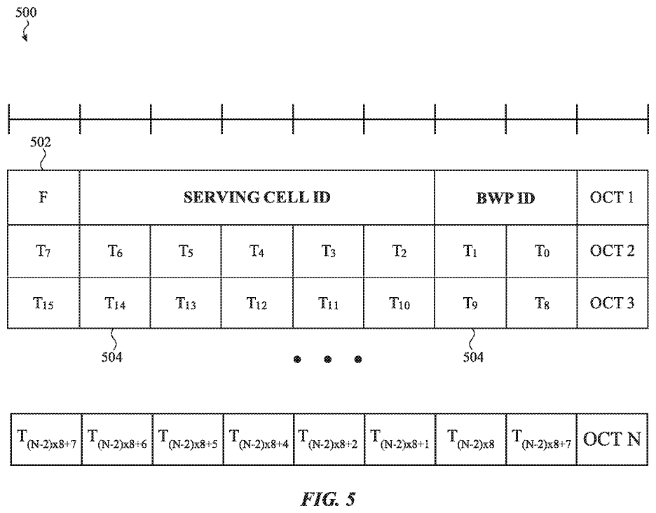

FIG. 5 illustrates an example a MAC control element (MAC CE) format, according to embodiments described herein. In some embodiments, at least one indication to activate the at least one TCI state may be received in one or more MAC CEs. When the at least one indication to activate the at least one TCI state is received in one or more MAC CEs, as shown in FIG. 5, a MAC CE 500 of the at least one MAC CE may identify a number of (one or more) TCI states or TCI codepoints corresponding to the at least one TCI state that is to be activated, and the MAC CE 500 may identify whether this is based on an AI based algorithm or a non-AI based algorithm in a field marked by “F” and identified as 502 as applied to each of the number of TCI states or TCI codepoints 504. Other fields of the MAC CE 500 may be as defined in 3GPP TS 38.321 § 6.1.3.14.

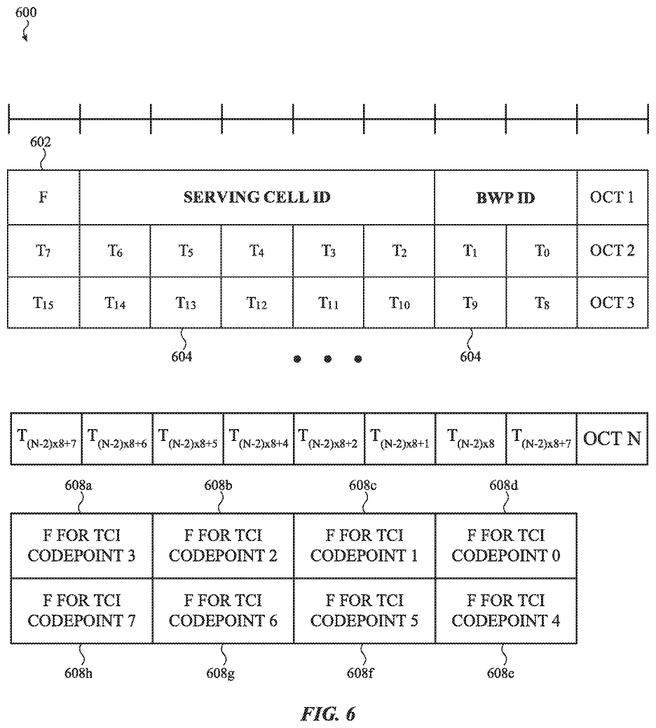

FIG. 6 illustrates another example of a MAC control element (MAC CE) format, according to embodiments described herein. In some embodiments, at least one indication to activate the at least one TCI state may be received in one or more MAC CEs. When the at least one indication to activate the at least one TCI state is received in one or more MAC CEs, as shown in FIG. 6, a MAC CE 600 of the at least one MAC CE may identify a number of (one or more) TCI states or TCI codepoints corresponding to the at least one TCI state that is to be activated, and the MAC CE 600 may identify whether this is based on an AI based algorithm or a non-AI based algorithm in a field marked by “F for TCI codepoint X” identified as 608a-608h corresponding to each of the number of TCI states or TCI codepoints 604, where X is any value including 0-7. Other fields of the MAC CE 600 may be as defined in 3GPP TS 38.321 § 6.1.3.14.

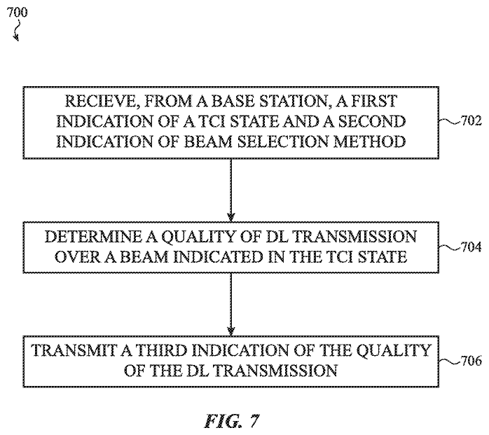

FIG. 7 illustrates an example flow-chart of operations being performed by a UE, according to embodiments described herein. As shown in a flow-chart 700, at 702, at a UE including a transceiver and a processor, a first indication of a TCI state and a second indication of whether a beam selected for DL transmission to the UE is selected based on an AI based algorithm or a non-AI based algorithm. As described herein, in accordance with some embodiments, the TCI state indicator may be received using RRC signaling or in a MAC CE or DCI. Further as described herein, an indication of whether a beam for DL transmission is selected based on an AI based algorithm may be per MAC CE based or per TCI codepoint based, as described herein using FIG. 5 and FIG. 6.

In some embodiments, at 704, the UE may determine a quality of one or more DL transmissions (or a first set of one or more DL transmissions) transmitted over the beam that are selected using an AI based algorithm and indicated in the TCI state indicator received at 702. As described herein, the quality of one or more DL transmissions (or a second set of one or more DL transmissions) transmitted over an alternate beam or a second beam may also be determined. The quality of the first set or the second set of one or more DL transmissions may be determined by performing signal strength measurements using RSRP (e.g., L1-RSRP) measurement or SINR (e.g., L1-SINR) measurement for the beam selected using an AI based algorithm and for the alternate or second beam selected using a non-AI based algorithm. Signal strength measurements may be performed using DL transmissions including at least one of a channel state information reference signal (CSI-RS), a demodulation reference signal (DMRS) of a physical downlink shared channel (PDSCH), a DMRS of a physical downlink control channel (PDCCH), or synchronization signal blocks (SSBs).

In some embodiments, and by way of a non-limiting example, the quality of one or more DL transmissions over the beam selected using an AI based algorithm and for the alternate or second beam selected using a non-AI based algorithm may be determined using channel quality indicators (CQIs). In some cases, the quality of one or more DL transmissions over the beam selected using an AI based algorithm and for the alternate or second beam selected using a non-AI based algorithm may be determined according to CSI-reportConfig received at the UE from a base station.

At 706, the UE may transmit to the base station an indication of the quality of the one or more DL transmissions (e.g., ACK/NACK) at least partly in response to the quality of the one or more DL transmissions. The ACK or NACK may be transmitted based on comparing of the quality of the beam selected using an AI based algorithm and a second beam selected using a non-AI based algorithm. If the beam selected using an AI based algorithm has better quality over the quality of the second beam, then the UE may transmit an ACK to the base station for the received TCI state indicator at 702. Otherwise, the UE may send a NACK to the base station, as described herein, in accordance with some embodiments.

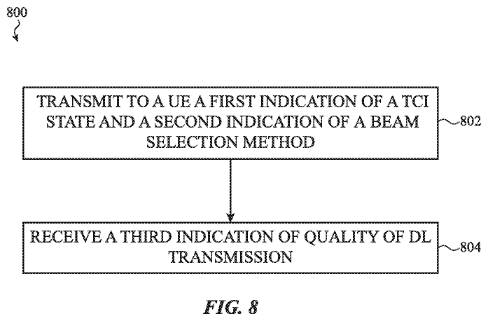

FIG. 8 illustrates an example flow-chart of operations being performed by a base station, according to embodiments described herein. A base station may be an eNB, an eNodeB, a gNB, and so on. As shown in a flow-chart 800, at 802, a base station including a transceiver and a processor, may transmit, to a UE, a first indication of a TCI state and a second indication of whether a beam selected for DL transmission to the UE is selected based on an AI based algorithm or a non-AI based algorithm. As described herein, in accordance with some embodiments, the TCI state indicator may be transmitted using RRC signaling or in a MAC CE or DCI. Further as described herein, an indication of whether a beam for DL transmission is selected based on an AI based algorithm may be per MAC CE based or per TCI codepoint based, as described herein using FIG. 5 and FIG. 6.

In some embodiments, at 804, an indication of a quality of one or more DL transmissions (e.g., ACK/NACK) may be received by the base station from the UE at least partly in response to the quality of the one or more DL transmissions to the UE from the base station. The ACK or NACK may be transmitted by the UE based on comparing the quality of the beam selected using an AI based algorithm and a second beam selected using a non-AI based algorithm. If the beam selected using an AI based algorithm has better quality over the quality of the second beam, then the UE may transmit an ACK to the base station for the received TCI state indicator at 802. Otherwise, the UE may send a NACK to the base station, as described herein, in accordance with some embodiments.

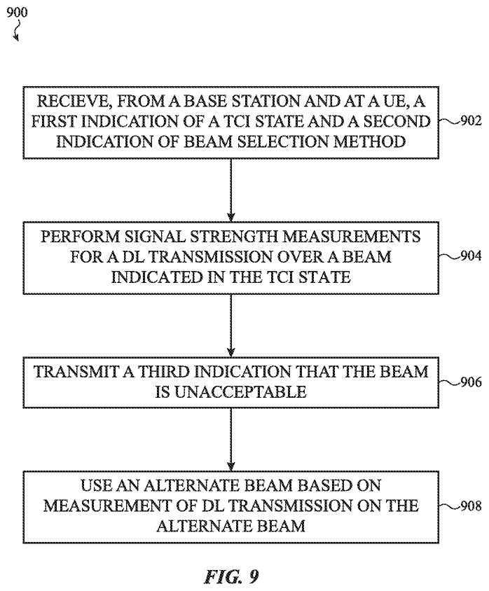

FIG. 9 illustrates another example flow-chart of operations being performed by a UE, according to embodiments described herein. As shown in a flow-chart 900, at 902, at a UE including a transceiver and a processor, a first indication of a TCI state and a second indication of whether a beam selected for DL transmission to the UE is selected based on an AI based algorithm or a non-AI based algorithm. As described herein, in accordance with some embodiments, the TCI state indicator may be received using RRC signaling or in a MAC CE or DCI. Further as described herein, an indication of whether a beam for DL transmission is selected based on an AI based algorithm may be per MAC CE based or per TCI codepoint based, as described herein using FIG. 5 and FIG. 6.

In some embodiments, at 904, the UE may perform signal strength measurement or quality measurements for one or more DL transmissions transmitted over the beam that is selected using an AI based algorithm and indicated in the TCI state indicator received at 902. As described herein, the quality of one or more DL transmissions transmitted over an alternate beam or a second beam may also be determined. The quality of one or more DL transmissions may be determined by performing signal strength measurements using RSRP (e.g., L1-RSRP) measurement or SINR (e.g., L1-SINR) measurement for the beam selected using an AI based algorithm and for the alternate or second beam selected using a non-AI based algorithm. Signal strength measurements may be performed using DL transmissions including at least one of a channel state information reference signal (CSI-RS), a demodulation reference signal (DMRS) of a physical downlink shared channel (PDSCH), a DMRS of a physical downlink control channel (PDCCH), or synchronization signal blocks (SSBs).

In some embodiments, and by way of a non-limiting example, a quality of one or more DL transmissions over the beam selected using an AI based algorithm and for the alternate or second beam selected using a non-AI based algorithm may be determined using channel quality indicators (CQIs). In some cases, the quality of one or more DL transmissions over the beam selected using an AI based algorithm and for the alternate or second beam selected using a non-AI based algorithm may be determined according to CSI-reportConfig received at the UE from a base station.

In some embodiments, at 906, the UE may transmit to the base station an indication of the quality of the one or more DL transmissions (e.g., ACK/NACK) corresponding to the quality of the one or more DL transmissions. The ACK or NACK may be transmitted based on comparing the quality of the beam selected using an AI based algorithm and a second beam selected using a non-AI based algorithm. If the beam selected using an AI based algorithm has better quality over the quality of the second beam, then the UE may transmit an ACK to the base station for the received TCI state indicator at 902. Otherwise, the UE may send a NACK to the base station, as described herein, in accordance with some embodiments.

In some embodiments, at 908, the UE may perform signal strength measurements for the one or more DL transmissions transmitted over an alternate beam (e.g., a second beam) for communication with the base station. The alternate beam may be selected by at least one of the UE or the base station based on measurements of one or more DL transmissions transmitted to the UE on the alternate beam. By way of a non-limiting example, the alternate beam or the second beam may be selected using a non-AI based algorithm or using a legacy beam selection procedure.

Embodiments contemplated herein include an apparatus having means to perform one or more elements of the method 700, 800, or 900. In the context of method 700, or 900, this apparatus may be, for example, an apparatus of a UE (such as a wireless device 1102 that is a UE, as described herein). In the context of method 800, this apparatus may be, for example, an apparatus of a base station (such as a network device 1120 that is a base station, as described herein).

Embodiments contemplated herein include one or more non-transitory computer-readable media storing instructions to cause an electronic device, upon execution of the instructions by one or more processors of the electronic device, to perform one or more elements of the method 700, 800, or 900. In the context of method 700, or 900, this non-transitory computer-readable media may be, for example, a memory of a UE (such as a memory 1106 of a wireless device 1102 that is a UE, as described herein). In the context of method 800, this non-transitory computer-readable media may be, for example, a memory of a base station (such as a memory 1124 of a network device 1120 that is a base station, as described herein).

Embodiments contemplated herein include an apparatus having logic, modules, or circuitry to perform one or more elements of the method 700, 800, or 900. In the context of method 700, or 900, this apparatus may be, for example, an apparatus of a UE (such as a wireless device 1102 that is a UE, as described herein). In the context of method 800, this apparatus may be, for example, an apparatus of a base station (such as a network device 1120 that is a base station, as described herein).

Embodiments contemplated herein include an apparatus having one or more processors and one or more computer-readable media, using or storing instructions that, when executed by the one or more processors, cause the one or more processors to perform one or more elements of the method 700, 800, or 900. In the context of method 700, or 900, this apparatus may be, for example, an apparatus of a UE (such as a wireless device 1102 that is a UE, as described herein). In the context of the method 800, this apparatus may be, for example, an apparatus of a base station (such as a network device 1120 that is a base station, as described herein).

Embodiments contemplated herein include a signal as described in or related to one or more elements of the method 700, 800, or 900.

Embodiments contemplated herein include a computer program or computer program product having instructions, wherein execution of the program by a processor causes the processor to carry out one or more elements of the method 700, 800, or 900. In the context of method 700, or 800, the processor may be a processor of a UE (such as a processor(s) 1104 of a wireless device 1102 that is a UE, as described herein), and the instructions may be, for example, located in the processor and/or on a memory of the UE (such as a memory 1106 of a wireless device 1102 that is a UE, as described herein). In the context of method 800, the processor may be a processor of a base station (such as a processor(s) 1122 of a network device 1120 that is a base station, as described herein), and the instructions may be, for example, located in the processor and/or on a memory of the base station (such as a memory 1124 of a network device 1120 that is a base station, as described herein).

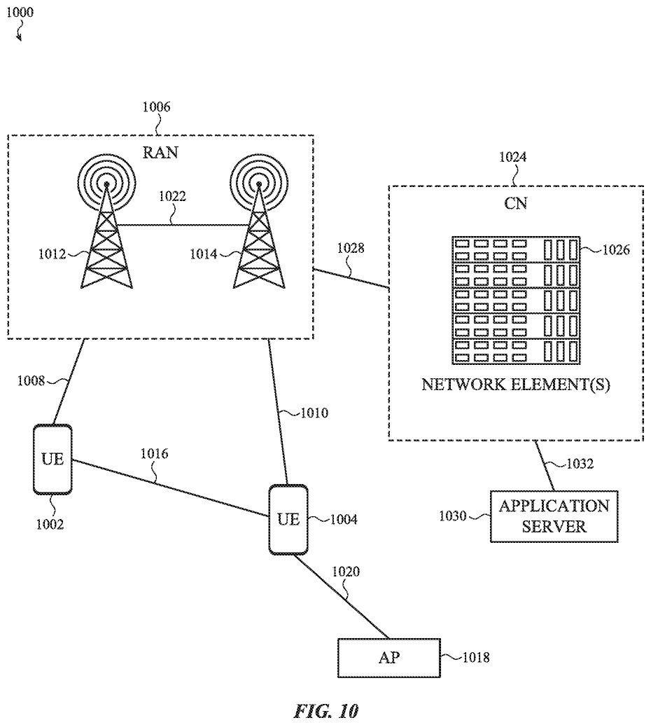

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations, such as base station 1012 and base station 1014, that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

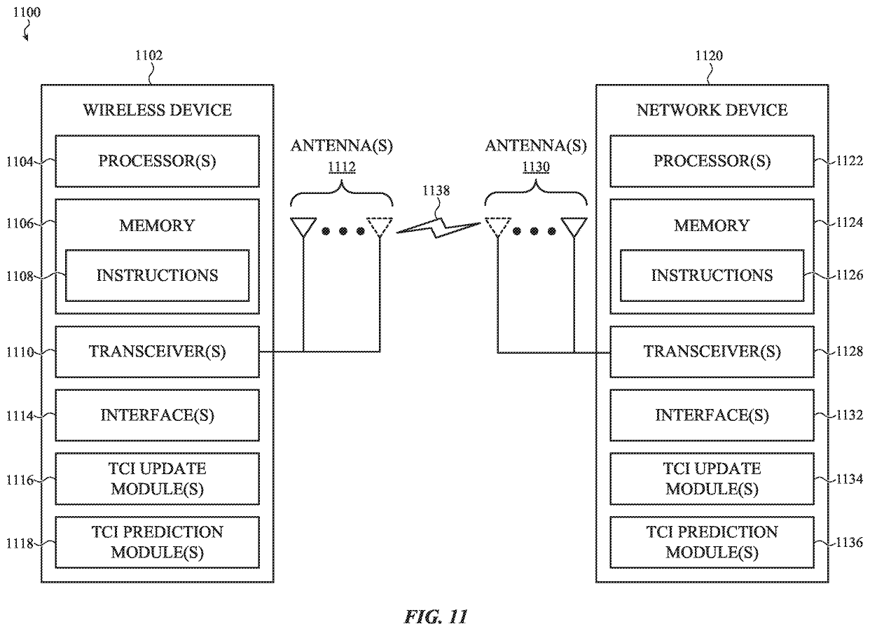

FIG. 11 illustrates a system 1100 for performing signaling 1138 between a wireless device 1102 and a network device 1120, according to embodiments disclosed herein. The system 1100 may be a portion of a wireless communications system as herein described. The wireless device 1102 may be, for example, a UE of a wireless communication system. The network device 1120 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter and/or receiver circuitry that use the antenna(s) 1112 of the wireless device 1102 to facilitate signaling (e.g., the signaling 1138) to and/or from the wireless device 1102 with other devices (e.g., the network device 1120) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include a TCI update module 1116 and/or a TCI prediction module 1118. The TCI update module 1116 and TCI prediction module 1118 may be implemented via hardware, software, or combinations thereof. For example, the TCI update module 1116 and TCI prediction module 1118 may be implemented as a processor, circuit, and/or instructions 1108 stored in the memory 1106 and executed by the processor(s) 1104. In some examples, the TCI update module 1116 and TCI prediction module 1118 may be integrated within the processor(s) 1104 and/or the transceiver(s) 1110. For example, the TCI update module 1116 and TCI prediction module 1118 may be implemented by a combination of software components (e.g., executed by a DSP or a general processor) and hardware components (e.g., logic gates and circuitry) within the processor(s) 1104 or the transceiver(s) 1110.

The TCI update module 1116 may be used for various aspects of the present disclosure, for example, aspects of FIGS. 1-9. The TCI update module 1116 may be configured to, for example, active or apply one or more TCI states indicated by another device (e.g., the network device 1120).

The TCI prediction module 1118 may be used for various aspects of the present disclosure, for example, aspects of FIGS. 1-9. The TCI prediction module 1118 may be configured to, for example, predict at least one beam that should be of satisfactory quality for at least one transmission (on a DL or an UL) at a future time.

The network device 1120 may include one or more processor(s) 1122. The processor(s) 1122 may execute instructions such that various operations of the network device 1120 are performed, as described herein. The processor(s) 1122 may include one or more baseband processors implemented using, for example, a CPU, a DSP, an ASIC, a controller, an FPGA device, another hardware device, a firmware device, or any combination thereof configured to perform the operations described herein.

The network device 1120 may include a memory 1124. The memory 1124 may be a non-transitory computer-readable storage medium that stores instructions 1126 (which may include, for example, the instructions being executed by the processor(s) 1122). The instructions 1126 may also be referred to as program code or a computer program. The memory 1124 may also store data used by, and results computed by, the processor(s) 1122.

The network device 1120 may include one or more transceiver(s) 1128 that may include RF transmitter and/or receiver circuitry that use the antenna(s) 1130 of the network device 1120 to facilitate signaling (e.g., the signaling 1138) to and/or from the network device 1120 with other devices (e.g., the wireless device 1102) according to corresponding RATs.

The network device 1120 may include one or more antenna(s) 1130 (e.g., one, two, four, or more). In embodiments having multiple antenna(s) 1130, the network device 1120 may perform MIMO, digital beamforming, analog beamforming, beam steering, etc., as has been described.

The network device 1120 may include one or more interface(s) 1132. The interface(s) 1132 may be used to provide input to or output from the network device 1120. For example, a network device 1120 that is a base station may include interface(s) 1132 made up of transmitters, receivers, and other circuitry (e.g., other than the transceiver(s) 1128/antenna(s) 1130 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1120 may include a TCI update module 1134 and/or a TCI prediction module 1136. The TCI update module 1134 and TCI prediction module 1136 may be implemented via hardware, software, or combinations thereof. For example, the TCI update module 1134 and TCI prediction module 1136 may be implemented as a processor, circuit, and/or instructions 1126 stored in the memory 1124 and executed by the processor(s) 1122. In some examples, the TCI update module 1134 and TCI prediction module 1136 may be integrated within the processor(s) 1122 and/or the transceiver(s) 1128. For example, the TCI update module 1134 and TCI prediction module 1136 may be implemented by a combination of software components (e.g., executed by a DSP or a general processor) and hardware components (e.g., logic gates and circuitry) within the processor(s) 1122 or the transceiver(s) 1128.

The TCI update module 1134 may be used for various aspects of the present disclosure, for example, aspects of FIGS. 1-9. The TCI update module 1134 may be configured to, for example, activate or indicate one or more TCI states to be used by another device (e.g., the wireless device 1102).

The TCI prediction module 1136 may be used for various aspects of the present disclosure, for example, aspects of FIGS. 1-9. The TCI prediction module 1136 may be configured to, for example, predict at least one beam that should be of satisfactory quality for at least one transmission between a UE (e.g., the wireless device 1102) and at least one cell (on a DL or an UL) at a future time.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
receive, from a base station and via the transceiver,
a first indication of a transmission configuration indicator (TCI) state; and
a second indication of whether a beam selected for downlink (DL) transmission to the UE, which beam is identified by the TCI state, was selected based on an artificial intelligence (AI) based algorithm;
determine a quality of one or more DL transmissions transmitted over the beam; and
transmit, to the base station and via the transceiver, at least partly in response to the quality of the one or more DL transmissions, a third indication of the quality of the one or more DL transmissions.

2. The UE of claim 1, wherein:
the beam is a first beam;
the one or more DL transmissions are a first set of one or more DL transmissions; and
the processor is configured to,
determine a quality of a second set of one or more DL transmissions transmitted over a second beam, the second beam selected based on a beam sweeping technique;
compare the quality of the first set of the one or more DL transmissions with the quality of the second set of the one or more DL transmissions;
determine, at least partly based on the comparison, the quality of the second set of the one or more DL transmissions is greater than the quality of the first set of the one or more DL transmissions by an offset threshold; and
transmit, to the base station and via the transceiver, a fourth indication to suggest the quality of the second set of the one or more DL transmissions is greater than the quality of the first set of the one or more DL transmissions.

3. The UE of claim 2, wherein the quality of the first set of the one or more DL transmissions or the quality of the second set of the one or more DL transmissions is determined by performing signal strength measurements using a layer-1 reference signal received power (L1-RSRP) measurement or a layer-1 signal-to-interference-plus-noise-ratio (L1-SINR) measurement.

4. The UE of claim 2, wherein the first set of the one or more DL transmissions or the second set of the one or more DL transmissions comprises at least one of: a channel state information reference signal (CSI-RS), a demodulation reference signal (DMRS) of a physical downlink shared channel (PDSCH), a DMRS of a physical downlink control channel (PDCCH), or a synchronization signal block (SSB).

5. The UE of claim 2, wherein:
the processor is configured to,
determine channel quality indicators corresponding to the first beam and the second beam based on at least one of a reference signal received power (RSRP) measurement or a signal-to-interference-plus-noise-ratio (SINR) measurement; and
transmit, to the base station and via the transceiver, and at least partly in response to the determined channel quality indicators, a fifth indication of the determined channel quality indicators corresponding to the first beam and the second beam.

6. The UE of claim 2, wherein the quality of the first set of the one or more DL transmissions or the quality of the second set of the one or more DL transmissions is determined by performing signal strength measurements in accord with a CSI-reportConfig received from the base station.

7. The UE of claim 2, wherein:
the processor is configured to,
select the second beam upon transmitting a predetermined number of consecutive indications suggesting the quality of the second set of the one or more DL transmissions is greater than the quality of the first set of the one or more DL transmissions by the offset threshold.

8. The UE of claim 7, wherein:
the second beam is selected for receiving the second set of the one or more DL transmissions after transmitting a request to the base station to use the second beam; and
the processor is configured to,
transmit the request, to the base station and via the transceiver, in a medium access control (MAC) control element (CE) (MAC CE); and
request a resource for the MAC CE using a dedicated scheduling request (SR), a normal SR, or a contention based random access procedure.

9. The UE of claim 1, wherein the second indication of whether the beam selected for downlink (DL) transmission to the UE was selected based on the AI based algorithm, is received by the UE using radio resource control (RRC) signaling, a medium access control (MAC) control element (CE) (MAC CE), or downlink control information (DCI).

10. The UE of claim 9, wherein the DCI includes a control channel element (CCE) index, a radio network temporary identifier (RNTI), or a field identifying a criterion used by the base station for selection of the beam.

11. The UE of claim 1, wherein:
the third indication of the quality of the one or more DL transmissions is transmitted using a physical uplink control channel (PUCCH) resource indicated by the base station; and
the third indication is transmitted as a dedicated acknowledgement (ACK), a dedicated non-acknowledgement (NACK), an ACK, or a NACK multiplexed with another ACK or another NACK.

12. A base station, comprising:
a transceiver; and
a processor configured to,
transmit, to a user equipment (UE) and via the transceiver,
a first indication of a transmission configuration indicator (TCI) state; and
a second indication of whether a beam selected for downlink (DL) transmission to the UE, which beam is identified by the TCI state, was selected based on an artificial intelligence (AI) based algorithm; and
receive, from the UE and via the transceiver, a third indication of a quality of one or more DL transmissions transmitted over the beam.

13. The base station of claim 12, wherein the processor is configured to deactivate selection of the beam for the DL transmission using the AI based algorithm.

14. The base station of claim 12, wherein:
the beam is a first beam;
the one or more DL transmissions are a first set of one or more DL transmissions; and
the processor is configured to,
deactivate selection of the first beam for the DL transmission using the AI based algorithm, in response to receiving a predetermined number of consecutive indications suggesting the quality of the one or more DL transmissions transmitted over the first beam is less than an offset threshold below a quality of a second set of one or more DL transmissions transmitted over a second beam, the second beam selected by the UE based on a beam sweeping technique.

15. The base station of claim 14, wherein the processor is configured to deactivate selection of the first beam for the DL transmission using the AI based algorithm, in response to receiving a request from the UE to not select a beam using the AI based algorithm.

16. The base station of claim 12, wherein:
the beam is a first beam; and
a request from the UE is received after a predetermined number of consecutive indications suggesting the quality of the one or more DL transmissions over the beam is below an offset threshold in comparison with a quality of DL transmission over a second beam, the second beam selected by the UE based on a beam sweeping technique.

17. A method of a user equipment (UE), comprising:
receiving, from a base station and at the UE, a first indication of a transmission configuration indicator (TCI) state and a second indication of whether a beam for downlink (DL) transmission to the UE, which beam is identified by the TCI state, was selected based on an artificial intelligence (AI) based algorithm;
performing, by the UE, signal strength measurements for one or more (DL) transmissions transmitted using the beam;
transmitting, by the UE and based on the signal strength measurements, a third indication that the beam is unacceptable; and
after performing the signal strength measurements for the one or more DL transmissions transmitted using the beam, using an alternate beam for communication with the base station, the alternate beam selected by at least one of the UE or the base station based on signal strength measurements of one or more second DL transmissions transmitted to the UE on the alternate beam.

18. The method of claim 17, wherein the beam is selected using a common resource pool or a separate resource pool.

19. The method of claim 17, wherein:
the beam is a first beam;
the alternate beam is a second beam;
the one or more DL transmissions transmitted using the first beam are a first set of one or more DL transmissions;
one or more DL transmissions transmitted using the second beam are a second set of one or more DL transmissions;
the third indication is transmitted at least partly based on a comparison of a quality of the second set of the one or more DL transmissions being greater than a quality of the first set of the one or more DL transmissions by an offset threshold; and
the offset threshold is configured using a radio resource control (RRC) signaling or predefined.

20. The method of claim 17, further comprising
transmitting, by the UE and based on the signal strength measurements, a fourth indication that the beam is acceptable, the fourth indication transmitted using at least one bit of a multiplexed hybrid automatic repeat request acknowledgement (HARQ-ACK).
